(19) United States
(12) Patent Application Publication
(10) Pub. No.: US 2026/0150875 A1
(43) Pub. Date: Jun. 4, 2026

(54) Device For Peeling The Skins Of Almonds and Nuts

(71) Applicant: Roig Borrell S.L., Denia (Alicante) (ES)

(72) Inventor: Jose Vicente Roig Borrell, Denia (Alicante) (ES)

(21) Appl. No.: 19/396,302

(22) Filed: Nov. 20, 2025

(30) Foreign Application Priority Data
Dec. 3, 2024 (ES) 202432246

(51) Int. Cl. A23N 5/00

(52) U.S. Cl. CPC A23N 5/002

(57) ABSTRACT

A device for peeling the skins of almonds and nuts presented herein and includes a peeling mechanism, a conveyor tray for the peeled grains and the skins of the almonds/nuts, and at least one first suction device that acts on the tray to remove the skins prior to collecting the grain. A pressurized air blower is arranged after the first suction device according to the direction of movement of the grains in the tray. This first blower is capable of generating an air stream on the grains to separate the skins that remain attached to the grain.

### TECHNICAL FIELD OF THE INVENTION

The present invention corresponds to the technical field of machinery for the processing of nuts, in particular to peeling machines for nuts such as almonds and the like.

### BACKGROUND OF THE INVENTION

Many nuts, as is the case of almonds, have inside a shell, a grain or cotyledon wrapped in a skin or tegument that is adhered to said grain to a greater or lesser extent. The aim of the peeling machines is to act on the already shelled grain to completely remove the skin from the grain.

These machines usually have pairs of rollers or overlapping rollers. These rollers are driven by motors to generate their rotation, and are separated from each other by a certain distance that allows the passage of the nuts between them, so that the action of the rotation of the rollers on the surface of the nut causes the detachment of the skins.

The grain and skin set falls into a conveyor tray wherein normally a suction device performs a suction with sufficient power to remove the skins located in the tray, without affecting the grains, which continue their movement on the tray.

In practice, a problem has been observed in these machines because, on many occasions, although the rollers peel the grain, they are not able to completely separate both elements and the skin is detached from the grain, but adhered to it by an area.

These skins, as they are attached to the grain, cannot be removed by means of the suction device, and continue to be attached to the grain as it travels on the conveyor tray, which implies the need to make a new selection of those nuts that still have the skin attached to the grain to pass them through the suction device again.

This entails a reduction in the efficiency and performance of the peeling machine, for which reason it is necessary to find a way to solve this problem.

### DESCRIPTION OF THE INVENTION

The device for peeling the skins of almonds and nuts presented herein is applied to the peeling machines of these nuts, which comprise a peeling mechanism, a conveyor tray for the peeled grains and the skins, and at least one first suction device that acts on the tray to remove the skins prior to collecting the grain.

This device for peeling comprises at least a first pressurized air blower arranged after the first suction device according to the direction of movement of the grains in the tray. This first blower is capable of generating an air stream on the grains to separate the skins that remain attached to the grain.

The air stream generated by the blower acts over substantially the entire width of the tray, for example a proportion significant enough to act on the grains and skins moving through the device and the air stream is oriented in the opposite direction to the grain movement with an angle of inclination between 30 and 45° with respect to the direction of movement, and with a speed between 10 and 25 m/s.

A significant improvement of the state of the art is obtained with the device for peeling almond and nuts skins proposed herein.

This is the case as a device is achieved that can be coupled to any peeling machine to increase its effectiveness.

With this device, it is possible to separate those skins that after peeling have remained adhered to the grain, because an air jet is generated that acts as a blade that cuts the grain's travel, keeping it for a longer time under the effect of the suction device to allow a separation of the skins to be achieved even in those cases in which it is more adhered to the grain. In addition, by retaining the grain during a time, it enables the amount of nut that continues its movement in the tray to be arranged in a thin layer, without accumulations, which is what is desired.

The air jet on the nuts has a controlled speed that allows the skins that remain adhered to the fruit to be torn off, but it is not sufficient to prevent the grain, now without skin, from finally following its path of travel on the tray.

It is, therefore, a very effective device for peeling that manages to solve the current problem with those skins that are more difficult to separate.

### BRIEF DESCRIPTION OF THE DRAWINGS

In order to aid in a better understanding of the characteristics of the invention, in accordance with a preferred example of practical embodiment thereof, a series of drawings is provided as an integral part of said description wherein, with illustrative and non-limiting character, the following has been represented:

FIG. 1.—Shows a profile view of the peeling machine with the device for peeling almond and nut skins, for a first preferred embodiment of the invention.

FIG. 2.—Shows a schematic view of the operation of the device for peeling almond and nut skins, for a first preferred embodiment of the invention.

FIG. 3.—Shows a schematic view of the operation of the device for peeling almond and nut skins, for a second preferred embodiment of the invention.

### DETAILED DESCRIPTION OF A PREFERRED EMBODIMENT OF THE INVENTION

In view of the figures provided, it can be observed how in a first preferred embodiment of the invention, the device for peeling the skins of almonds and nuts proposed herein is suitable for a machine for peeling these nuts comprising a peeling mechanism (8), a conveyor tray (1) of the peeled grains (2) and the skins (3), and at least a first suction device (4.1) that acts on the tray (1) to remove the skins (3) prior to the collection of the grain (2).

This device comprises a first pressurized air blower (5.1) arranged after the first suction device (4.1) according to the direction of movement (7) of the grains (2) in the tray.

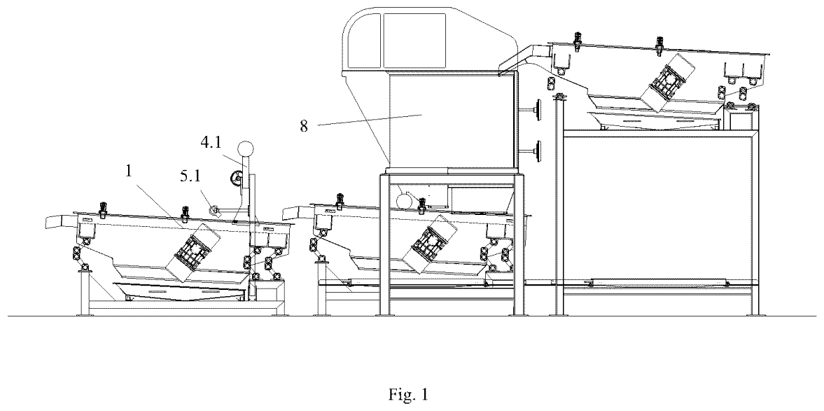

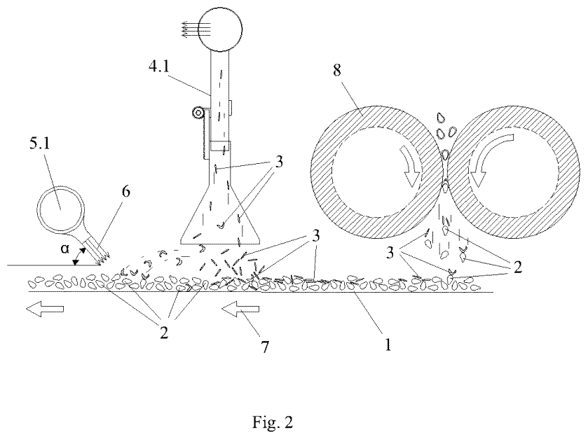

As shown in FIGS. 1 and 2, this first blower (5.1) is capable of generating an air stream (6) on the grains (2) to separate the skins (3) that remain attached to the grain (2) after passing through the first suction device (4.1).

The air stream (6) generated by the first blower (5.1) acts on the entire width of the tray (1) with an orientation in the opposite direction to that of grain movement, an angle of inclination (α) between 30 and 45° with respect to the direction of movement, and with a speed between 10 and 25 m/s.

This speed allows the air jet to slow down the travel of the grains and act on the skins (3) separating them from the grain (2), but does not prevent the grains from finally continuing their travel in the conveyor tray (1).

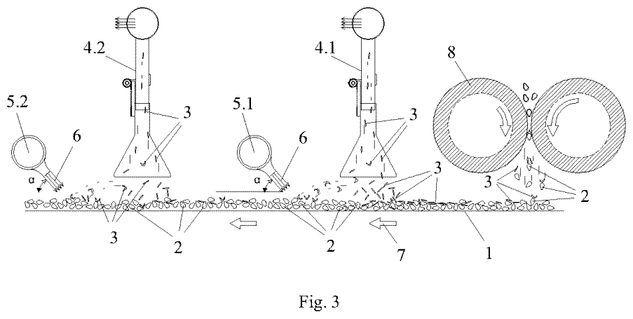

In a second preferred embodiment of the invention, shown in FIG. 3, the device for peeling comprises a second pressurized air blower (5.2). In other cases, it could have a higher number.

This second pressurized air blower (5.2) is associated with a second suction device (4.2) configured to be installed in the peeling machine after the first suction device according to the direction of movement (7) of the grains (2) in the tray (1).

In this second preferred embodiment, the blowers (5.1, 5.2) have the same characteristics of speed and angle of action on the grain.

Thus, with this second blower greater efficiency is achieved in those situations wherein, due to the state of the grain, humidity or any other circumstance, it is concluded that a blower is not sufficient to separate those skins that have remained adhered to certain grains and therefore, the suction device is not able to remove them.

1. A Device for peeling the skins of almonds and/or nuts comprising:
a peeling mechanism;
a conveyor tray for conveying peeled grains of the almonds and/or nuts and skins of the almonds and/or nuts;
at least one first suction device that acts on the conveyor tray to remove the skins prior to the collection of the grain;
at least one first blower of pressurized air arranged after the first suction device according to the direction of movement of the grains in the conveyor tray, configured to generate an air stream on the grains to separate the skins that remain attached to the grain, wherein said air stream acts on substantially the entire width of the tray with an orientation in the opposite direction to that of movement of the grain, an angle of inclination (α) between 30 and 45° with respect to the direction of movement, and with a speed between 10 and 25 m/s.

2. The device according to claim 1, wherein the device for peeling comprises a second pressurized air blower associated with a second suction device configured to be installed in the peeling machine after the first suction device according to the direction of movement of the grains in the tray.

3. The device according to claim 2, wherein the first and second blowers have the same speed and angle of action characteristics on the grain.
